(19) United States
(12) Patent Application Publication
(10) Pub. No.: US 2012/0292887 A1
(43) Pub. Date: Nov. 22, 2012

(54) SNOWBOARD BINDING LOCKING LEVER PULL CABLE

(76) Inventor: Todd Ohlheiser, Lafayette, CO (US)

(21) Appl. No.: 13/564,537

(22) Filed: Aug. 1, 2012

Related U.S. Application Data
(60) Provisional application No. 61/592,496, filed on Jan. 30, 2012.

(51) Int. Cl. A63C 9/00; B23P 11/00

(52) U.S. Cl. 280/611; 29/428

(57) ABSTRACT

The present invention is directed generally towards closing a snowboard binding locking lever with a pull cable that protrudes forward, upward, or upward and forward from the highback of the binding. One aspect of the invention provides a pull cable with a cable guide and a grip. Another aspect includes a semi-rigid bendable guide to act as an additional guide for the pull cable. Another aspect includes a magnet or notch to fasten the grip towards the front of the binding.

### CROSS REFERENCE TO RELATED APPLICATIONS

This application claims the benefit of U.S. Provisional Patent Application No. 61/592,496, filed on Jan. 30, 2012, which is incorporated by reference herein in its entirety for all purposes.

### BACKGROUND OF THE INVENTION

1. Field of the Invention

The field to which this invention pertains is snowboard bindings with rear-mounted locking levers.

2. Description of Related Art

Snowboards are well-known in the art and in the sporting world, various types of bindings have been developed to allow the user to engage their boots to the snowboard. The present disclosure is described with reference to popular snowboard bindings; however, the present invention may readily be adapted to other applications involving bindings with rear-mounted locking levers.

Conventional snowboard binding systems used with soft snowboard boots are generally categorized as either strap bindings that typically include a rigid highback piece against which the heel of the boot is placed and one or more straps that secure the boot to the binding or step-in bindings that typically utilize one or more strapless engagement members into which the rider can step to lock the boot into the binding. Strap bindings are the original and most popular type of snowboard bindings and are adjustable, secure, and comfortable. Step-in bindings allow the user to more easily engage and disengage from the snowboard.

Both strap bindings and step-in bindings usually include a pivotable highback ankle support that extends upwardly from the snowboard. The back ankle portion of the rider's boot abuts against a curved forward surface of the highback, essentially providing leverage by which the rider can control the snowboard's heel edge. It will be appreciated that a rider must typically engage and disengage the binding many times over the course of a day of snowboarding; generally while the rider is on the slopes and, typically, with gloved hands. Unlike skiing, snowboarding requires the user to engage or disengage their rear-boot every time they get on or off a lift, thus a snowboarder consumes more of their time on the slopes engaging and disengaging their bindings. The binding is typically engaged and disengaged using a lever disposed on the back of the highback. This lever can be difficult for the rider to grab because its position in the unlocked position is very low to the ground near the surface of the snowboard and behind the snowboarder; therefore, it can be difficult to physically reach to the end of the locking lever to engage the binding.

Because the snowboarder must typically balance on their heels or toes to maintain stability on an sloping ski hill, it is exceptionally difficult to maintain balance while crouching low and reaching backwards to close the locking lever of a binding; because of this, many snowboarders must sit down on a ski hill to close the locking lever of a binding. Prior inventions, such as U.S. Pat. No. 7,246,811 to Martin, have attached cords or straps to the locking lever in order to make closure of the rear-mounted lever easier; however, these inventions have failed to bring to the location where the user grasps the cord or strap to a position either forward, above, or forward and above the highback; so that the snowboarder can easily reach such cord or strap while in a standing or crouched position. Thus, the snowboard rider is more likely to be forced to sit down on the slope.

### SUMMARY

There is a need for a pull cable or strap to close the locking lever of a snowboard binding that allows the snowboarder to remain balanced from a standing or crouched position without causing the snowboard rider to reach backwards or sit down. The present invention solves this problem by allowing the user to grasp a pull cable or strap from a grip situated in an elevated, forward, or elevated and forward position from the highback of the binding; bringing the rear-mounted locking lever into a locking position while the user is in a standing or crouching position. Some of the embodiments of the following invention are as follows.

A snowboard binding locking lever pull cable or strap is disclosed comprising a semi-rigid pull cable or strap attached to the locking lever on a highback of a binding. A cable or strap guide is attached to the top half of the highback through which the semi-rigid pull cable or strap extends. The semi-rigid pull cable or strap has a grip on the opposite end from the attachment to the locking lever, which the cable or strap guide directs in a forward, upward, or forward and upward direction towards the snowboarder's downward reaching hand. When the snowboarder pulls the grip end of the semi-rigid pull cable or strap, the locking lever of the binding moves more easily from open to closed.

In another embodiment of the invention, the pull cable or strap is routed through a spring or other semi-rigid bendable guide that is attached to the upper portion of the highback such that the semi-rigid bendable guide extends forward from the highback of the binding and toward the grip end of the pull cable or strap. The semi-rigid bendable guide helps the pull cable or strap maintain either its upwards, forwards, or upwards and forwards orientation so that the grip remains in a convenient position for the snowboarder to access without sitting or reaching backwards. This semi-rigid bendable guide is an important addition to the invention when the highback of the binding it is attached to pivots further backwards and closer to the ground. The semi-rigid bendable guide can also help guide the boot of the snowboarder into the binding.

In another embodiment the semi-rigid bendable guide or spring is made with a bend or arch to help bring the grip of the pull cord or strap to an easier position to grasp. The arch shape can also bring the grip of the cord or strap toward a location where it can more easily be secured.

In another embodiment of the invention, the semi-rigid bendable guide has a cover that enshrouds the semi-rigid bendable guide. The semi-rigid bendable guide cover has two openings coaxially aligned with the pull cable or strap that allow the pull cable or strap to pass into and out of the cover, and therefore the semi-rigid bendable guide as well. The cover allows the pull cable or strap to continue moving freely inside the semi-rigid bendable guide by protecting the semi-rigid bendable guide from becoming packed up with snow, ice, or mud.

In another embodiment of the invention, the grip contains a magnetic element that attracts to another magnetic element located on the front of the binding. This feature secures the pull cable so that it stays out of the way once the snowboarder has closed the locking lever and is riding. This magnetic attachment also allows the binding locking lever to be released without the need to release the pull cord or strap first.

In another embodiment of the invention, the front of the binding contains a slot, inside which the grip of the pull cable or strap is designed to fit snuggly. This feature secures the pull cable so that it stays out of the way once the snowboarder has closed the locking lever and is riding. This prevents the pull cable from catching on objects on the ski-slope terrain and injuring the rider.

In another embodiment of the invention, the invention comprises a method for pulling a rear-mounted binding locking lever closed from a location either forward, above, or forward and above the highback of the binding; and a means for guiding the pulling element to a position where a user can grasp it without sitting down.

In another embodiment of the invention, the invention is a method comprising the steps of: standing with the boot in the binding and the locking lever in an open position; bending to grasp the grip of a pull cable or strap without sitting down; pulling upwards on the grip of the pull cable or strap; and closing the rear-mounted lever located on the binding. In a further embodiment of the invention, the method additionally includes the step of securing the grip to the front of the binding.

In another embodiment of the invention, the invention can be made a part of the binding upon creation of the binding or it can be an additional attachment made to the binding after the original creation of the binding.

These and other needs are addressed by the various aspects, embodiments, and/or configurations of the present disclosure. Also, while the disclosure is presented in terms of exemplary embodiments, it should be appreciated that individual aspects of the disclosure can be separately claimed.

### OBJECTS AND ADVANTAGES

The present disclosure can provide a number of advantages depending on the particular aspect, embodiment, and/or configuration. None of the particular objects or advantages that follow must be entirely satisfied as they are non-exclusive alternatives and at least one of the following objects is met; accordingly, several objects and advantages of the present invention are:

(a) to provide a means for a user to bring the rear-mounted lever of a binding into a locked position with reduced physical effort;

(b) to provide a means for a user to bring the rear-mounted lever of a binding into a locked position that is quicker and more efficient than current means;

(c) to provide a means for a user to bring the rear-mounted lever of a binding into a locked position without leaning backwards;

(d) to provide a means for a user to bring the rear-mounted lever of a binding into a locked position without having to sit or kneel down;

(e) to provide a means for a user to bring the rear-mounted lever of a binding into a locked position by pulling upwards or forward from the user's center of gravity;

(f) to provide a means for a user to bring the rear-mounted lever of a binding into a locked position that is easier to reach from an upright position, while in motion, or while the snowboard is sliding forward; thus giving the rider the ability to close the locking lever of the binding at the top of every ski lift without slowing down; allowing the snowboarder to function like a skier that does not have to stop and fasten a binding;

(g) to provide a means for a user to bring the rear-mounted lever of a binding into a locked position that can be used and reused on multiple bindings;

(h) to provide a means for a user to bring the rear-mounted lever of a binding into a locked position that can also be used as a means to carry a snowboard comfortably;

(i) to provide a means for a user to guide a boot into a binding by following semi-rigid bendable guide;

(j) these and other objectives and advantages of the instant invention will become apparent from the following description taken in conjunction with the accompanying drawings wherein are set forth, by way of illustration and example, certain embodiments of the instant invention. The drawings constitute a part of this specification and include exemplary embodiments of the present invention and illustrate various objects and features thereof

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

### BRIEF DESCRIPTION OF THE DRAWINGS

1. FIGURES

FIG. 1 (on Sheet 1) illustrates an isometric perspective view of a step-in snowboard binding with rear-mounted lever in the unlocked position with a pull cable according to embodiments of the present invention.

FIG. 2 (on Sheet 1) illustrates an isometric perspective view of a snowboard binding with rear-mounted lever in the locked position with a pull cable according to embodiments of the present invention.

FIG. 3 (on Sheet 2) illustrates an isometric perspective view of a snowboard binding with bent rear-mounted lever with a cable channel in the unlocked position with a pull cable according to embodiments of the present invention.

FIG. 4 (on Sheet 2) illustrates various parts used to attach a pull cable to a binding according to embodiments of the present invention.

FIG. 5 (on Sheet 3) illustrates an isometric perspective view of a snowboard binding with a semi-rigid bendable guide and mounting bracket according to embodiments of the present invention.

FIG. 6 (on Sheet 4) illustrates an isometric perspective view of a snowboard binding with an angled semi-rigid bendable guide and semi-rigid bendable guide cover according to embodiments of the present invention.

FIG. 7 (on Sheet 5) illustrates an isometric perspective view of a snowboard binding with an angled semi-rigid bendable guide, and the grip stored against the toe end of the binding according to embodiments of the present invention.

### DETAILED DESCRIPTION OF A PREFERRED EMBODIMENT

For the purposes of promoting an understanding of the principles of the invention, reference will now be made to the embodiments illustrated in the drawings and specific language will be used to describe the same. However, the illustrated embodiments are merely exemplary and many additional embodiments of this invention are possible. For example, a snowboard binding is pictured; however, this invention can be applied to any binding attaching a boot to a sports gear with a rear-mounted locking lever. It is understood that no limitation of the scope of the invention is thereby intended. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal,” “vertical,” “left,” “right,” “up,” and “down”; as well as adjectival and adverbial derivatives thereof (e.g., “horizontally,” “rightwardly,” “upwardly,” etc.) simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1. The Locking Lever Pull Cable

Shown throughout the figures, the instant invention is generally directed toward a pull cable attached to a rear-mounted locking lever of a snowboard binding.

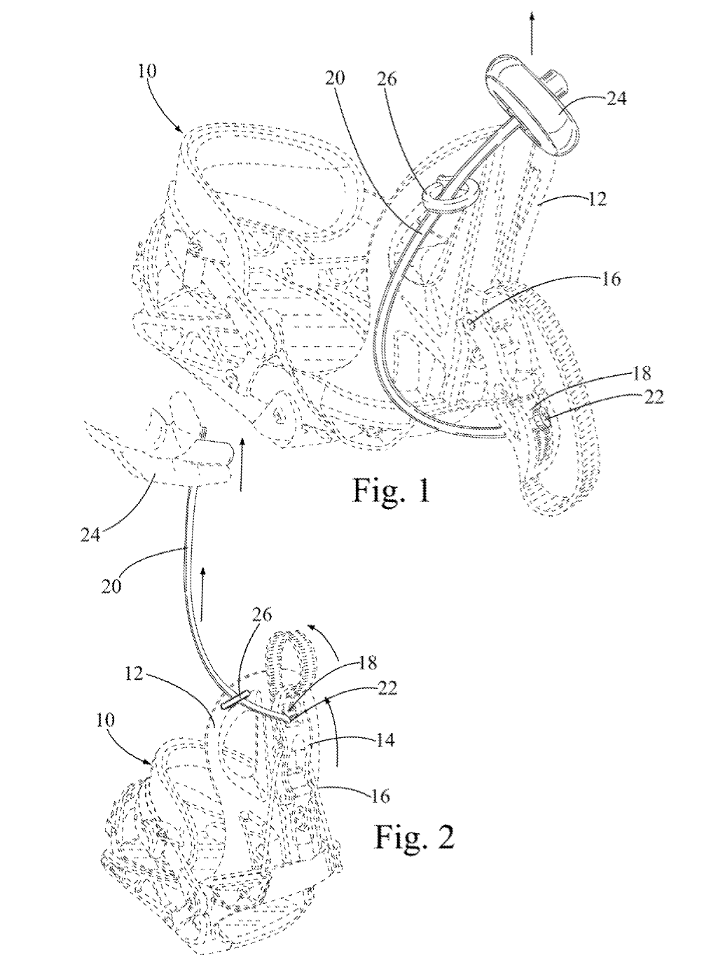

FIG. 1 is a perspective view of a common step-in type snowboard binding with a front toe section (10) and a rear-mounted lever (14) in the unlocked position. The step-in snowboard binding has a highback (12) that has a locking lever (14) with an aperture (18) that works about a pivot (16) in the vertical direction. A pull cable (20), cord, rope, pull, strap or equivalent is attached to the locking lever (14). Such attachment may be by any means of securely preventing the pull cable (20) from detaching from the locking lever (14): as shown the means for attachment of the pull cable or strap is a protrusion that may be a crimp (22) applied to the end of the pull cable (20) that prevents the pull cable from pulling through an aperture in the locking lever (18). The end of the pull cable (20) that is distal from the locking lever may have a grip (24), handle, pull, loop, or similar functional element that can allow the user of the binding to conveniently grasp the pull cable (20). The pull cable (20) then threads through a cable guide (26) that is either molded into, attached directly to, or a drilled into the highback (12) of the binding in a position that is off-center from the vertical axis of the highback (12) and above the attachment of the pull cable (20) to the locking lever (14). The cable guide (26) can be a part of, or mounted to, either side or the center of the top of the highback. The cable guide (26) can be made of any material suitable for its purpose, which is preferably plastic or metal; and made in any arrangement that allows the pull cable (20) to pass through it and be directed in either a forward, an upward, or a forward and upward direction.

FIG. 2 shows the same binding and embodiment of the invention as FIG. 1, except that it illustrates a hand (24) pulling the pull cable (20) in a forward and upward manner, thereby closing the locking lever (14).

It is important to realize that a snowboarder trying to close the locking lever on a binding is often balancing on his heels or toes while on a slope. It is difficult to stoop down and reach behind a binding highback while balancing on one's heels or toes: the further a snowboarder must reach, the more likely he is to lose his balance and fall over.

FIGS. 1 and 2 illustrate several features of one embodiment of the present invention. Firstly, the pull cable (20) can be semi-rigid; this allows the pull cable (20) to maintain an upright position against gravity; this in-turn allows the snowboarder to grasp the grip of the pull cable (24) from a position that is higher than the location of the cable guide (26) on the highback (12) of the binding. If the pull cable (20) being semi-rigid was not rigid enough to easily support its own weight and maintain itself in an upright position it would fall below the height of the cable guide (26) and highback (12) and thereby impairing the user's ability to grasp the grip (24) easily. Additionally, if the pull cable (20) were too rigid it would become prone to damage and could cause injury to the user.

Secondly, the cable guide (26) is located asymmetrically to the vertical axis of the highback (12) on the upper end of the highback. This feature allows the portion of the pull cable (20) that protrudes above the cable guide (26) when the rear-mounted locking lever (14) is in the down position to protrude forward, to the side, or past the leg of the user; toward the reaching hand of the user while the user crouches or leans downward.

It is common for step-in bindings to function by utilizing a rear-mounted locking lever that engages a cable connecting the pivotable sidewalls attached to a sole plate, such that the assembly simultaneously moves the highback and the instep straps, or other forward locking mechanism, into position about a rider's boot. Because the instep straps, or other forward locking mechanism, and highback are tightened simultaneously; there is less resistance against the highback when the foot is flexed upwards towards the shin of the user. Snowboarders are often balancing on their heels with their front side facing down the slope. Because a snowboarder is balancing on his heels, when he leans forward or crouches directly downward, his feet naturally curl upwards toward his shins; thereby allowing the locking lever of the binding to be placed in the locked position with less resistance. Because there is less resistance to the closure of the binding when pulling directly up or forward from the snowboarder's center of balance, less force is required. Because less force is required, the movement is quicker and the snowboarder is less likely to lose balance. This same principle applies whether the snowboarder is balancing on the toe side or heel side of the snowboard. This same principle also allows the present embodiments of the invention to allow the snowboard to fasten their binding without sitting down.

When the pull cable (20) is located above the cable guide (26) and to the side of the leg, the snowboarder will pull the pull cable (20) directly upwards, or forwards, or upwards and forwards from his center of balance, at a higher position than reaching for the locking lever without the aid of the embodiments of the claimed invention. While the snowboarder is in motion on a ski slope, he can gently reach to a convenient location for the pull cable; thereby allowing him to easily secure the binding while maintaining balance in an upright position.

The performance advantages are clear when considering the alternatives. When balancing on a snowboarder's heels or toes, it is more difficult to grasp a pull cable that is behind the foot on the highback than it is to grasp a cable or cord that is raised higher and to the side, or in front of the leg; likewise, without a grip that one can pull directly upward or forward from one's center of gravity, maintaining one's balance becomes much more difficult. Reaching down and behind a snowboarder's leg to operate the locking lever additionally causes extension in the angle between the foot and the ankle, creating resistance on the highback that makes it much harder to close the locking lever. Extension between the foot and the ankle further increases the likelihood the snowboarder will lose his balance and not be able to secure his boot to his binding without sitting down.

Thirdly, the asymmetrical location of the cable guide (26) on the highback (12) acts as a pivot point for the pull cable (20) thereby decreasing the force necessary for the snowboarder to lock the rear-mounted lever (14). Again, the easier it is for the snowboarder to close the locking lever, the more likely that he will maintain his balance.

Fourthly, the asymmetrical location of the cable guide (26) allows the semi-rigid pull cable (20) to be pulled directly upward or forward while the snowboarder maintains their center of gravity without causing the pull cable to rub against the user's leg causing discomfort or wear to their clothing.

Fifthly, the pull cable (20) can, and preferably is (when installed as a post market add-on to common step in bindings as opposed to built into the binding at the factory), threaded through the aperture (18) in the rear-mounted locking lever (14) and over the top of the locking lever when it is in the locked position as shown in FIGS. 1 and 2. This provides several advantages: firstly, it creates a second pivot point on the top of the locking lever thereby decreasing the force necessary for the user to lock the rear-mounted lever (14); secondly, it prevents a pull cable from preventing the closure of the locking lever by coming between the locking lever and the highback; thirdly, and counter-intuitively, the pivot point (16) of the locking lever (14) itself aids in the closing of the locking lever until the locking lever crosses the horizontal plane at which point the force necessary to close the locking lever also increases due to the resistance felt as the binding secures the boot, having the pull cable loop over the thickness of the locking lever allows the pull cable (20) to create an angle between the pivot (16) of the locking lever (14) and the pivot point of the cable guide (26) that achieves greater mechanical advantage.

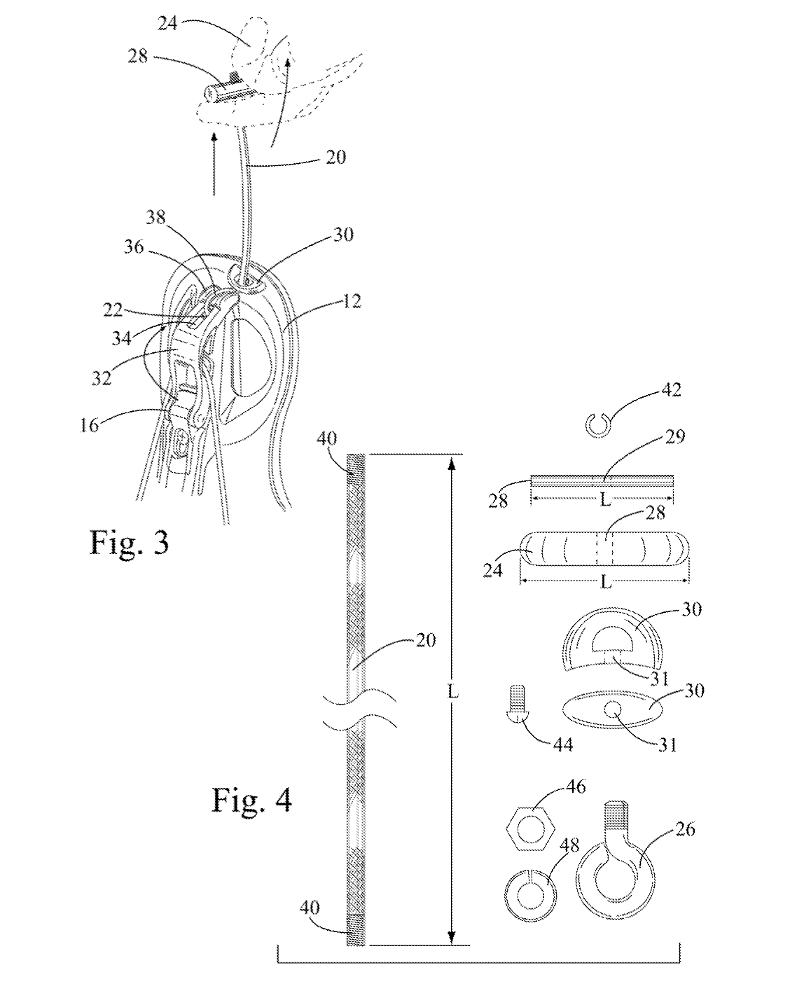

FIG. 3 shows a perspective view of an alternate embodiment of the invention which is similar to the embodiment in FIGS. 1 and 2, with a few new features. One of these features is that the locking lever (32) is bent above its hinge (16). The bend in the locking lever (32) allows the pull cable (20) to be channeled more directly into the cable guide (30), changing the point of wear on the locking lever from the side of the locking lever to its top. In the alternative, the locking lever could be straight without a bend, but installed with a hinge that is angled toward the cable guide, which would reduce angular tension on the locking lever's hinge, directing tension along the axis perpendicular to the axle of the hinge, thereby reducing wear on the axle of the hinge (16).

The embodiment of the invention shown in FIG. 3 also shows the use of a lever (32) that has a bulbous distal end (36) that serves the same function that the threading of the pull cable (20) over the locking lever serves, as explained above. This bulbous distal end (36) can have a channel running around its outward facing curve (38) that can cradle the pull cable (20) and keep it pointed towards the cable guide (30). In the alternative, the embodiment could include a locking lever (32) with an aperture (34) adapted to hold the end of the pull cable (20) at an ideal angle to prevent wear on the pull cable from repeated use. FIG. 3 also illustrates an alternative bar cable handle (28).

FIG. 4 shows a side view of an embodiment of the invention as separate parts. It is contemplated that this invention could be made and sold as an aftermarket accessory that users can install onto existing snowboard bindings. This invention is so designed that it can either be built into the binding or installed as an aftermarket add-on and possibly still be quickly and easily moved from one binding to another. The parts that may be used include: a pull cable (20) which may optionally have threaded regions on either end (40); handles such as a rounded disk (24), or a bar handle (29), with a region for attachment (28) that can accommodate the pass through of pull cable (20), the grip then attached to the semi-rigid pull cable by use of crimps (42) or by allowing the semi-rigid pull cable to screw directly into the grip. Depicted are two examples of a cable guide, including a stylized version that is lower profile and therefore less likely to cause injury (30), with a screw (44), and a threaded socket (31). In FIG. 4 one can also find a cable guide assembled from a standard threaded ring (26), nut (46), and washer (48) closure.

2. Method for Attaching the Pull Cable Depicted in FIGS. 1 Through 4

If a cable guide is not molded directly into the highback of the binding, the embodiments of this invention can easily be installed in virtually any snowboard binding with a rear-mounted locking lever containing an aperture with as little as two simple steps. First, drill a hole into the highback of the binding and insert a screw (44) through the highback and into a cable guide (30). Second, thread a semi-rigid pull cable (20) with a crimped (42), or otherwise secured, end through the inside of the aperture of the locking lever then through the cable guide (30). Finally, attach the grip (28) to the semi-rigid pull cable if necessary.

3. Using the Semi-rigid Pull Cable as a Means to Carry a Snowboard

In one embodiment of the present invention which is not pictured, the pull cables or straps have loops on their upward ends in place of, or in addition to, handles. Such loops are ideally placed to allow the user to carry their snowboard by placing such loops around their shoulders. Carrying the snowboard with such loops allows the board to be carried with the bindings opened and the flat of the bottom of the board against the flat of the user's back or front.

4. Using a Semi-rigid Bendable Guide for a Pull Cable

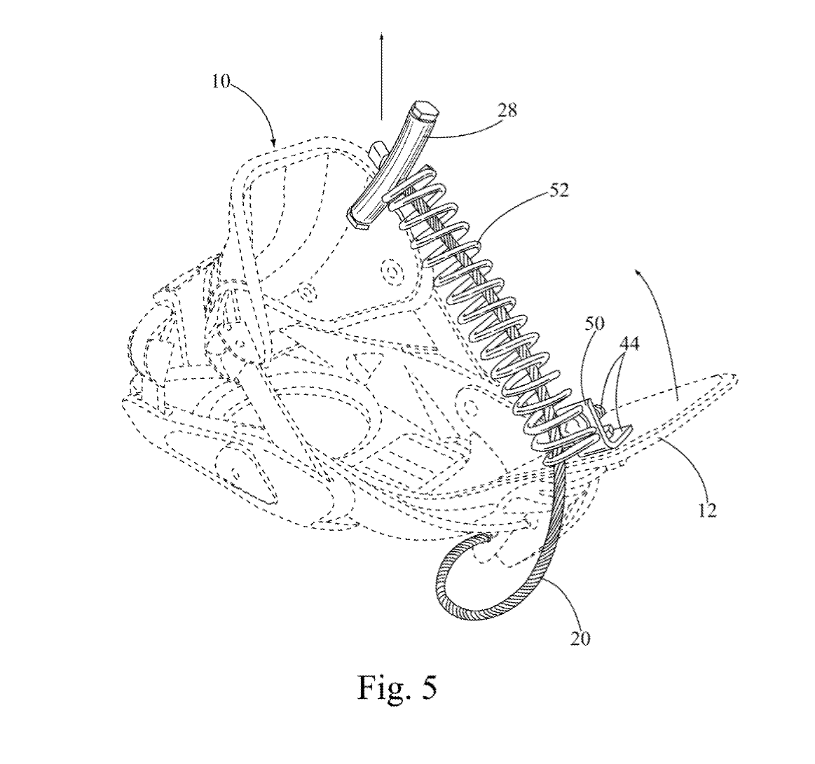

FIG. 5 depicts an embodiment of the claimed invention that includes a semi-rigid bendable guide (52), in this embodiment it is a spring. The semi-rigid bendable guide (52) is attached to the highback (12) with a bracket (50). In this embodiment of the invention the pull cord (20) has less reason to be semi-rigid as the semi-rigid bendable guide can guide the pull cord or strap to a position upward, forward, or upward and forward from the highback (12) of the binding. As illustrated, this embodiment accomplishes attaching the semi-rigid bendable guide (52) to the highback with one screw (44) which attaches a bracket (50) to the highback (12), and a second screw (44) which attaches the bracket (50) to the semi-rigid bendable guide (52). The semi-rigid bendable guide (52) is attached in such a way that it is directed upwards, forwards, or upwards and forwards towards the hands of the snowboarder, situated between the grip (28) and the highback (12). In alternative embodiments, the bracket (50) can be: an L-bracket, a straight bracket, a hinge; the semi-rigid bendable guide can also be molded to the highback (12), slot or snap into place, or any other suitable method of fixing the semi-rigid bendable guide (52) to the highback (12), with any number of screws or other articles or methods of attachment. The semi-rigid bendable guide bends to allow the rider to continue to pull the pull cord (20) in the upward plain as the rider stands upward; thereby allowing the rider to more easily maintain their balance and not have to sit down.

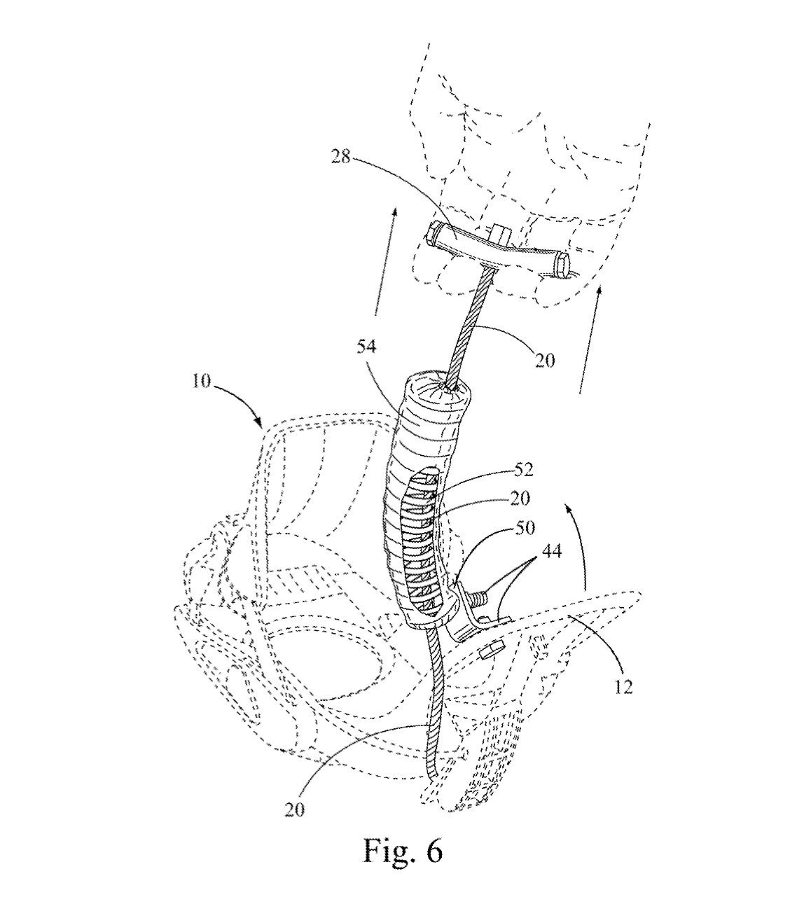

FIG. 6 depicts an embodiment of the claimed invention that includes a semi-rigid bendable guide cover (54) over a curved semi-rigid bendable guide (52) and a hand pulling upwards on the grip (28). The semi-rigid bendable guide cover (54) prevents the semi-rigid bendable guide (52) from becoming packed up with ice, snow, or mud so that the pull cable (20) continues to glide effortlessly inside the semi-rigid bendable guide (54). The angle of the semi-rigid bendable guide (52) can help to place the grip in a forward and inward position because it can slightly angle around the snowboarder's leg. The angled semi-rigid bendable guide (52) feature makes it even easier for the snowboarder to grasp the grip while maintaining a balanced position. Furthermore, the semi-rigid bendable guide (52) can also act as a guide to direct the boot into the binding before the snowboarder is ready to close the locking lever: whereby the snowboarder need not even look down to find the correct horizontal position of the foot for placing it within the binding.

5. Storing the Pull Cable Against the Binding

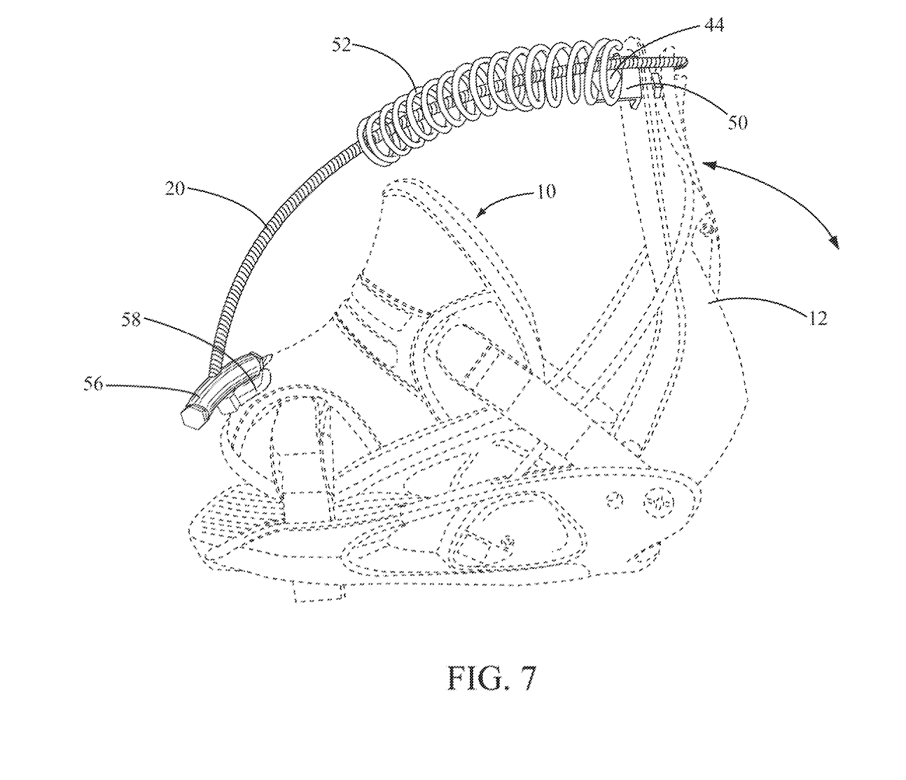

FIG. 7 depicts an embodiment of the claimed invention that includes a means to attach the grip to the toe region of the binding (10). The grip (56) contains a magnetic material and another magnet (58) is positioned on the toe region of the binding (10) such that the grip (56) and the magnet (58) are attracted to each other. The magnetic attachment allows for the easy stowage of the pull cable when the snowboarder desires. The magnetic attachment also allows for the rider to more easily release the stored pull cable without having to take another unnecessary step to release the pull cable. In an alternative embodiment, the grip (56) can be stored in a slot located on the toe area of the binding (10).

All patents and publications mentioned or incorporated into this specification are indicative of the levels of those skilled in the art to which the invention pertains. All patents and publications are herein incorporated by reference to the same extent as if each individual publication was specifically and individually indicated to be incorporated by reference.

It is to be understood that while certain forms of the invention are illustrated, it is not to be limited to the specific forms or arrangements herein described and shown. For example, a spring is used; however, in the alternative other semi-rigid bendable guides could be used, such as: tubes, connected rigid pieces, etc. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well-adapted to carry out the objectives and obtain the ends and advantages mentioned, as well as those inherent therein. The embodiments, methods, procedures, and techniques described herein are presently representative of the preferred embodiments; are intended to be exemplary; and are not intended as limitations on the scope. Changes therein and other uses will occur to those skilled in the art which are encompassed within the spirit of the invention and are defined by the scope of the claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims.

What is claimed is:

1. A pull cable for closing a rear-mounted locking lever located on a highback of a binding comprising:
a cable guide; and
a pull cable having a first end that is attachable to the rear-mounted locking lever and a second end extendable through the cable guide;
wherein, the second end of the pull cable is capable of extending through the cable guide forward from the highback of the binding;
wherein the pull cable can move the rear-mounted locking lever from an open to a closed position when the pull cable is attached to the rear-mounted locking lever and is pulled upon.

2. The pull cable for closing a rear-mounted locking lever located on a highback of a binding of claim 1, wherein the pull cable is semi-rigid.

3. The pull cable for closing a rear-mounted locking lever located on a highback of a binding of claim 1, further comprising a grip.

4. The pull cable for closing a rear-mounted locking lever located on a highback of a binding of claim 3, wherein the grip comprises a loop.

5. The pull cable for closing a rear-mounted locking lever located on a highback of a binding of claim 4, wherein the loop can be placed around a shoulder.

6. The pull cable for closing a rear-mounted locking lever located on a highback of a binding of claim 3, wherein the grip comprises a bar.

7. The pull cable for closing a rear-mounted locking lever located on a highback of a binding of claim 6, further comprising a slot on the binding into which the bar can be secured.

8. The pull cable for closing a rear-mounted locking lever located on a highback of a binding of claim 3, wherein the grip is made of a magnetic material.

9. The pull cable for closing a rear-mounted locking lever located on a highback of a binding of claim 8, further comprising a magnetic material on the binding to which the grip can be secured.

10. The pull cable for closing a rear-mounted locking lever located on a highback of a binding of claim 1, wherein said cable guide is molded into said highback of said binding.

11. The pull cable for closing a rear-mounted locking lever located on a highback of a binding of claim 1, wherein said cable guide is removably attached to said highback of said binding.

12. The pull cable for closing a rear-mounted locking lever located on a highback of a binding of claim 1, wherein the cable guide comprises a semi-rigid bendable guide.

13. The pull cable for closing a rear-mounted locking lever located on a highback of a binding of claim 12, wherein said semi-rigid bendable guide is curved.

14. The pull cable for closing a rear-mounted locking lever located on a highback of a binding of claim 12, wherein said semi-rigid bendable guide is attached to said highback of said binding with a bracket.

15. The pull cable for closing a rear-mounted locking lever located on a highback of a binding of claim 12, further comprising a semi-rigid bendable guide cover.

16. A method for closing a rear-mounted locking lever located on a highback of a binding comprising the steps of:
placing a boot in a binding with a locking lever in an open position;
pulling a pull cable through a cable guide located on the highback of the binding from a position forward of the highback of the binding thereby closing the lever;

17. The method of claim 16, further comprising the step of securing the pull cable to the binding once the lever is closed.

18. A method for attaching a pull cable to a binding with a rear-mounted locking lever located on a highback of said binding comprising the steps of:
attaching the pull cable to the rear-mounted locking lever;
attaching a pull cable guide to the highback of the binding;
putting the pull cable through the pull cable guide so that it extends forward of the highback of the binding.

19. The method of claim 18, further comprising the step of attaching a grip to the pull cable.
